(19) United States
(12) Patent Application Publication
(10) Pub. No.: US 2002/0092398 A1
(43) Pub. Date: Jul. 18, 2002

(54) Cutting device for plate material

(76) Inventors: Takeo Kawano, Tokushima (JP); Yasuo Hakamada, Tokushima (JP)

Correspondence Address: Wenderoth Lind & Ponack, 2033 K Street, N. W., Suite 800, Washington, DC, 20006, US

(21) Appl. No.: 09/511,397

(22) Filed: Feb. 23, 2000

(30) Foreign Application Priority Data
Feb. 24, 1999 (JP) 47258/1999
Feb. 18, 2000 (JP) 42035/2000

(51) Int. Cl. B26D 3/00

(52) U.S. Cl. 83/636; 83/51; 83/56; 83/620

(57) ABSTRACT

A cutting device for plate materials relatively transfers a plate material and cutter blades and cuts the plate material with a cutting portion of the cutter blades. The cutting portion is provided with a plurality of projecting cutter blades. The plurality of projecting cutter blades are separately disposed at fixed intervals in the direction which the plate material is transferred to the cutter blades and gradually projected larger toward the direction in which the plate material advances. The plurality of projecting cutter blades have inclined cutting edges which are acute cutting edges for cutting the plate material in such a manner as to be gradually inserted deeper into the plate material transferred to the cutter blades. The inclined cutting edges are inclined toward the direction in which the plate material is transferred so as to be gradually inserted deeper into the plate material.

This application is based on applications No.11-47258 filed in Japan on Feb. 24, 1999 and No. 2000-42035 filed in Japan on Feb. 18, 2000, the content of which incorporated hereinto by reference.

### BACKGROUND OF THE INVENTION

This invention relates to a device for linearly cutting all plane-shaped plate materials such as plywood, plaster board, MDF, plastic plate, rubber plate, leather plate and corrugated paper.

Compound materials such as plywood and plaster board are used generally in woodworking industrial fields such as housing, building, interior furnishings and furniture. Plate materials used for these purposes are cut to a pre-determined size and formed into the most suitable shape for the purposes. Circular and band saws are used for cutting the plate materials to a predetermined size.

A device for cutting plate materials to a pre-determined size was developed. The device is provided with a feeding mechanism for transferring a plate material to a saw while sandwiching the plate material between rollers and a cutting mechanism having a circular saw for cutting the plate material to a pre-determined width and disposed in the passage of the plate material sandwiched between the rollers, and a discharging mechanism for discharging the plate material so cut.

A cutting device with this structure generates a large amount of chips since the plate material is cut with a saw. The cutting device has the drawback that the cost for disposing of the chips becomes high since the chips are disposed by such a method as fire destruction. Further, when cutting the plate material, a width of 3 mm to 5 mm of the plate material is consumed as chips by the thickness of a saw cutter blade and its sets. For this reason, the cutting device has another drawback that the whole plate material can not be used efficiently. The narrower the plate material is cut, the more use efficiency is lowered. For example, if the plate material is cut to a width of 50 mm and a width of 5 mm of the plate material is consumed by a saw, approximately 10% of the plate material is consumed as chips for cutting the plate material. Thus the plate material can not be used efficiently.

Further, in the device for cutting a plate material with a saw, the noise level is remarkably high and the noise level near the cutting device reaches to 85 dB. It is remarkably difficult to deaden the noise made by such a high noise level cutting device, For this reason, the circumstances of establishing the factory are extremely limited.

Still further, if workers touch a high-speed rotating circular saw or a high-speed moving band saw, they are injured. This shows that the circular or band saws are extremely dangerous devices and the incidence of labor accidents is high. Therefore, a cutting device with the circular or band saws has the drawback that working circumstances can hardly be arranged to be safe.

In addition, the device for cutting a plate material with a saw has another drawback that the plate material can not be cut with a smooth cutting surface. This is because a multiplicity of saw cutting edges leave their cutting marks on the plate material. For this, a plate material used for the purpose accompanied with a clean cutting surface requires a process of cutting the plate material surface smoothly with a plane or making the plate material surface smoothly with sandpaper. Thus the cutting device requires a great deal of time and labor for a process of finishing the plate material.

Furthermore, in the device for cutting a plate material with a saw, the speed of transferring the plate material is limited. If the speed is increased, the saw is too much loaded. For this reason, the device for cutting a plate material with a saw has the drawback that it is difficult to make the speed of transferring the plate material high and cut the plate material efficiently.

As mentioned above, in the cutting device of prior art, the use efficiency of a plate material is low, the speed of cutting the plate material is also low, a large amount of chips are generated, devices such as a duct collector and an incinerator are necessary for disposing of the chips and the running cost is necessary for maintaining these devices. Thus the cutting device of prior art has the drawback that the cost for cutting plate materials becomes high. The present inventor developed a cutting device (Japanese Non-examined Patent Publication HEI 10-315206 ) shown in FIG. 1 to solve these problems. The cutting device shown in FIG. 1 is provided with a feeding mechanism 101 for linearly transferring a plate material B such as plywood in the fixed direction, a cutting mechanism 102 for cutting the plate material B fed by the feeding mechanism 101 to a fixed width with cutter blades disposed in the passage of the plate material B and a discharging mechanism 103 for discharging the plate material B cut so by the cutting mechanism 102.

Further, the cutting mechanism 102 is provided with cutter blades 32 disposed above and below the plate material B in a linear fashion for cutting the plate material from its both surfaces. A portion for cutting the plate material B is formed into a sheet-like shape and a cutting portion 32a formed in a sheet-like shape is disposed in parallel with the direction in which the plate material B is transferred. The cutting portion 32a of the upper cutter blade 32A disposed above the plate material B has an inclined cutting edge 32b inclining downwardly to the direction in which the plate material B is transferred. The inclined cutting edge 32b disposed in the upper cutter blade 32A has a tip cutting edge 32c at its tip. The cutting portion 32a of the lower cutter blade 32B disposed below the plate material B has an inclined cutting edge 32b inclining upwardly to the direction in which the plate material B is transferred. The inclined cutting edge 32b disposed in the lower cutter blade 32B has a tip cutting edge 32c at its tip. The tip cutting edges 32c of the upper cutter blade 32A and the lower cutter blade 32B are disposed in such a manner as to be displaced back and forth and the tip cutting edge 32c of the upper cutter blade 32A is extended lower than the tip cutting edge 32c of the lower cutter blade 32B.

A cutting device with this structure can cut a plate material safely, efficiently, fast and at a low noise level. Further, the cutting device with this structure can prevent the cutting loss of plate material and the generation of chips unlike the cutting device of prior art. Therefore, the cutting device with this structure can drastically reduce the consumption of the plate material and improve the use efficiency. Still further, it is not necessary to dispose of a large amount of chips since no chips are generated.

The cutting device shown in FIG. 1 can ideally cut a plate material as described above. However, cutter blades are actually broken when cutting the plate material according to the quality of plate materials. Especially cutter blades are easy to be broken when cutting a thick plate material which is partially hard. For example, cutter blades are bent and broken when cutting plywood which is thicker than a thickness of 30 mm and has partially hard plate in the layered. If the cutter blades are formed thick to solve this problem, they can not cut the plate material smoothly since the resistance produced in cutting the plate material becomes remarkably large. Further, another problem is that the cutter blades can not cut the plate material efficiently since the remarkably large resistance becomes even larger in cutting a thick plate material with thick cutter blades.

For this reason, the cutting device for plate materials shown in FIG. 1 can not always cut all quality of plate materials smoothly. Especially the cutting device can not cut a thick and hard plate material efficiently. Thus the cutting device has the drawback that the quality of plate materials which the cutting device can cut is limited and cutter blades are broken when cutting a plate material having a partially hard part. Once cutter blades are broken, it is necessary to change the cutter blades. Therefore this type of cutting device requires a great deal of time and labor in maintenance according to the quality of plate materials.

Further, the cross-section of a thick cutter blade is a triangle-like shape since the cutter blade is gradually formed thinner toward its cutting portion. When a plate material is cut with the cutter blade formed in a triangle-like shape, a cutting surface of the plate material is inclined. This is because the plate material is cut in such a manner which the cutting surface is pressed by a thick portion of the cutter blade. For this reason, the cutting surface of the plate material cut so requires a process of modifying according to the purposes. Thus the cutting device has the drawback that it requires a great deal of time and labor in a process of finishing.

The present invention was developed to resolve these types of problems with prior art cutting device. Thus it is a primary object of the present invention to provide a cutting device that can cut thick plate materials smoothly and efficiently while preventing cutter blades from being broken.

Further, it is another primary object of the present invention to provide a cutting device that can cut a multiplicity of plate materials at one time with simple mechanisms and with a clean cutting surface while remarkably reducing the cutting loss of thick plate materials.

The above and further objects and features of the invention will more fully be apparent from the following detailed description with accompanying drawings.

### SUMMARY OF INVENTION

A cutting device of the present invention relatively transfers a plate material B and cutter blades 4 and cuts the plate material B with the cutter blades 4. In the cutter blades 4, a portion for cutting the plate material B is at least formed in a sheet-like shape. A cutting portion 4a formed in a sheet-like shape is disposed in parallel with the direction in which the plate material is transferred. Further, the cutting device of the present invention is characterized in the following specific structures.

(a) A plurality of projecting cutter blades 15 are disposed in the cutting portion 4a.

(b) The plurality of projecting cutter blades 15 are separately disposed at fixed intervals in the direction which the plate material is transferred to the cutter blades 4 and gradually projected larger toward the direction in which the plate material B advances.

(c) The projecting cutter blades 15 have inclined cutting edges 4b which are acute cutting edges for cutting the plate material B in such a manner as to be gradually inserted deeper into the plate material B transferred to the cutter blades 4. The inclined cutting edges 4b are inclined to the direction in which the plate material B is transferred so as to be gradually inserted deeper into the plate material B.

The cutting device with this structure has the feature that a thick and hard plate material can be cut efficiently and smoothly while preventing cutter blades from being broken. This is because the cutting portion has the plurality of projecting cutter blades disposed separately at fixed intervals in the direction which the plate material is transferred, the projecting cutter blades are gradually projected larger toward the direction in which the plate material advances and provided with acute inclined cutting edges for cutting the plate material disposed in such a manner as to be gradually inserted deeper into the plate material. The cutting device with this structure can efficiently and gradually cut the plate material deeper with the plurality of projecting cutter blades and acute inclined cutting edges disposed in the projecting cutter blades.

The projecting cutter blade 15 is preferably provided with an acute inclined cutting edge 4b for cutting the plate material B on one side and an inclined edge not for cutting on the other side. Further, an oblique angle (α) of the inclined cutting edge 4b formed with the direction in which the plate material B is transferred to the cutter blades 4 is smaller than an oblique angle (β) of the inclined edge 4d formed with the direction. This is for the purpose of cutting the plate material B smoothly with the inclined cutting edge 4b. The inclined edge 4d is not provided with a cutting edge since it is not for cutting the plate material B. Therefore, this type of cutter blades can be manufactured at low cost since it is not necessary to provide the inclined edge 4d with a cutting edge.

The cutting device relatively transfers cutter blades 4 and a plate material B and cuts the plate material B with the cutter blades 4. However, this cutting device can cut the plate material B in such a manner which the cutter blades 4 are fixed and the plate material B is transferred to the cutter blades 4 or the plate material B is fixed and the cutter blades 4 are transferred to the plate material B. Further the cutting device can also cut the plate material B in such a manner which both the cutter blades 4 and the plate material B are transferred.

The cutter blades 4 can reduce frictional resistance to the plate material B by gradually forming a cutting portion 4a thinner toward the direction in which the plate material B is transferred.

The cutter blades 4 are disposed above and below a plate material B in a linear fashion and the plate material B is cut with a plurality of cutter blades 4 or a single cutter blade 4 which is disposed in such a manner as to pass through the plate material B. A cutting device with two cutter blades 4 can cut thick plate materials B efficiently. A cutting device with a single cutter blade 4 can cut the plate material B with a clean cutting surface.

Further, the cutter blades 4 can cut considerably thick plate materials B smoothly by connecting with an ultrasonic-vibrating mechanism 25 and being ultrasonic-vibrated thereby.

Still further, in the cutting device for plate materials of the present invention, a cutter blade 4 can be formed in a disk-shape. This cutting device has the following specific structures.

(a) A cutter blade 4 is disk-shaped and provided with an outer circumferential cutting portion 4C for cutting the plate material B on its outer circumference, which is at least formed into a sheet-like shape.

(b) The outer circumferential cutting portion 4C is disposed in parallel with the direction in which the plate material B is transferred to the cutter blade 4.

(c) The outer circumferential cutting portion 4C of the cutter blade 4 is provided with a plurality of projecting cutter blades 15 disposed separately in the direction of the circumference.

(d) Each projecting cutter blade 15 is provided with an inclined cutting edge 4b which is an acute cutting edge for cutting the plate material B on one side and an inclined edge 4d not for cutting the plate material B on the other side,

(e) An oblique angle (α) of the inclined cutting edge 4b formed with a circumferential tangent line is smaller than an oblique angle (β) of the inclined edge 4d formed with the line,

The cutting device with this structure also has the feature that it can cut a thick and hard plate material efficiently and smoothly while preventing cutter blades from being broken. This is because a cutter blade is formed in a disk-shape, an outer circumferential cutting portion of outer circumferetial part is provided with a plurality of projecting cutter blades which are separately disposed in the direction of the circumference, each projecting cutter blade is provided with an acute inclined cutting edge for cutting the plate material on one side and an inclined edge not for cutting on the other side and an oblique angle (α) of the inclined cutting edge 4b formed with the tangent line of the circumference is smaller than an oblique angle (β) of the inclined edge 4d formed with the line. The cutting device with this structure can efficiently and gradually cut the plate material deeper with the plurality of projecting cutter blades and acute inclined cutting edges disposed in the projecting cutter blades.

Further the cutting device described above can also realize the feature that a thick and hard plate material can be cut by simple mechanisms with a clean cutting surface while remarkably reducing the cutting loss of thick plate material.

The disk-shaped cutter blade 4 can efficiently cut the plate material B by rotating. However, the disk-shaped cutter blade 4 can also cut the plate material B in such a manner which the cutter blades 4 are fixed without rotating and the plate material B is transferred to the cutter blade 4.

In the cutter blade 4 capable of cutting the plate material B smoothly, the outer circumferential cutting portion 4C is formed thicker than the inner circumferential portion 4D. Further the disk-shaped cutter blade 4 has the feature that the cutter blades 4 can be manufactured in large quantities at low cost since it is not necessary to provide the inclined edge 4d with a cutting edge.

### BRIEF DESCRIPTION OF THE DRAWINGS

FIG. 1 is a schematic side view of a cutting device for cutting plate materials previously invented by the present inventor.

FIG. 2 is a schematic side view of an embodiment of the cutting device for cutting plate materials of the present invention.

FIG. 3 is a side view of an embodiment of the cutting device for cutting plate materials of the present invention.

FIG. 4 is a partial cross-sectional back side view of an embodiment of the cutting device for cutting plate materials of the present invention.

FIG. 5 is a side view of another embodiment of the cutting device for cutting plate materials of the present invention.

FIG. 6 is an enlarged cross-section view of cutter blades and the cutter blade installed structure of the cutting device shown in FIG. 3.

FIG. 7 is a front view of structure for attaching cutter blades shown in FIG. 6.

FIG. 8 is a partial cross-sectional side view of another embodiment of the cutting device for cutting plate materials of the present invention.

FIG. 9 is a partial cross-sectional side view of another embodiment of the cutting device for cutting plate materials of the present invention.

FIG. 10 is a partial enlarged front view of another embodiment of a cutter blade.

FIG. 11 is a cross-section view of the cutter blade shown in FIG. 10.

FIG. 12 is a front view of another embodiment of cutter blades.

FIG. 13 is a front view of another embodiment of cutter blades.

FIG. 14 is a front view of another embodiment of cutter blades.

FIG. 15 is a front view of another embodiment of cutter blades.

FIG. 16 is a front view of another embodiment of cutter blades.

FIG. 17 is a partial enlarged front view of another embodiment of a cutter blade.

FIG. 18 is an enlarged cross-section view of an embodiment of shape of a cutter blade end portion.

FIG. 19 is an enlarged cross-section view of another embodiment of shape of a cutter blade end portion.

FIG. 20 is an enlarged cross-section view of another embodiment of shape of a cutter blade end portion.

FIG. 21 is a schematic cross-section view from the side of another embodiment of the cutting device for plate materials of the present invention.

FIG. 22 is a schematic cross-section view from the front of the cutting device shown in FIG. 21.

FIG. 23 is a horizontal cross-section view showing a state that the plate material is fixed on the base of the cutting device shown in FIG. 21.

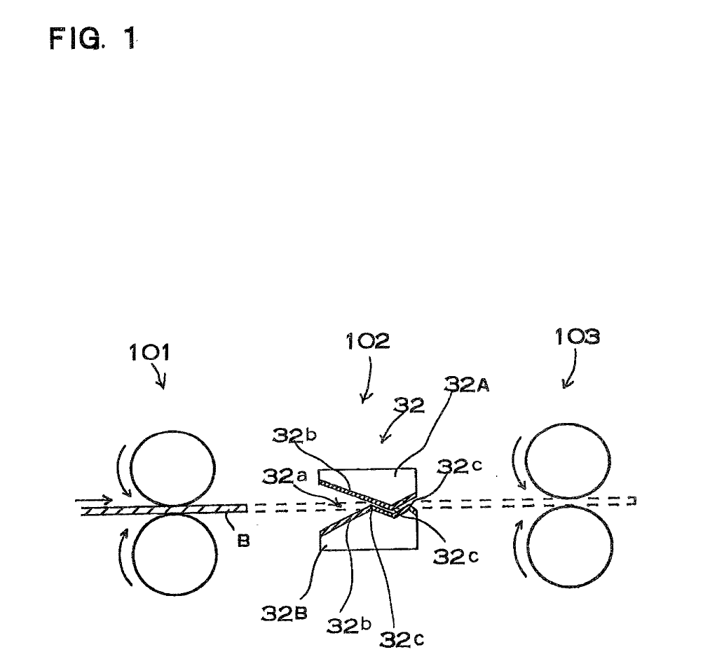

### DETAILED DESCRIPTION OF THE INVENTION

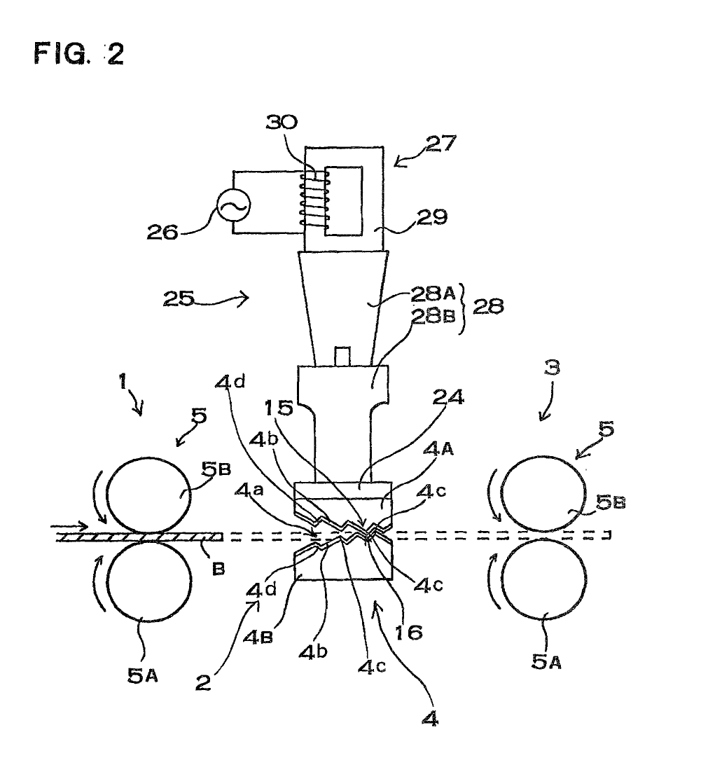

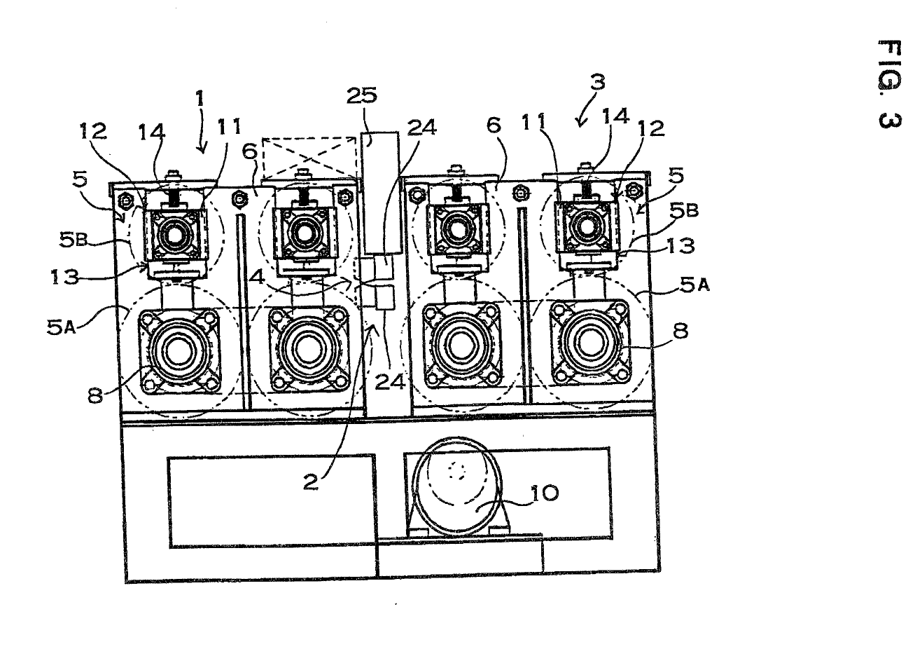

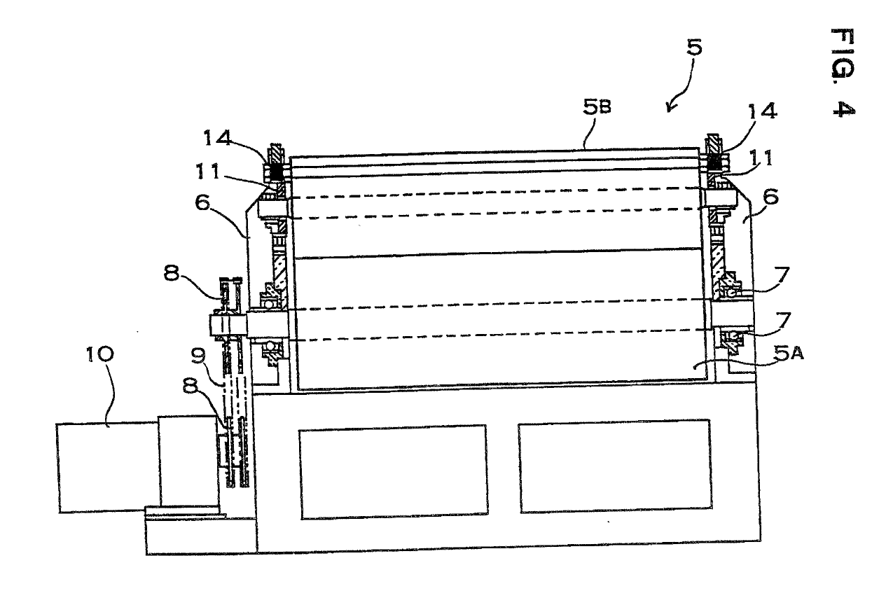

A cutting device shown in FIGS. 2 through 4 is provided with a feeding mechanism I for linearly transferring a plate material B such as plywood in the fixed direction, a cutting mechanism 2 for cutting the plate material B fed by the feeding mechanism 1 to a fixed width with cutter blades 4 which are provided in the passage of the plate material B, an ultrasonic-vibrating mechanism 25 for vibrating the cutter blades 4 of the cutting mechanism 2 and a discharging mechanism 3 for discharging the plate material B cut so by the cutting mechanism 2.

In the feeding and discharging mechanisms 1, 3, the plate material B is sandwiched between the upper and lower rollers and transferred. The feeding and discharging mechanisms 1, 3 are provided with driving rollers 5A disposed below the plate material B and pressing rollers 5B for pressing the upper surface of the plate material B.

The driving rollers 5A are horizontally disposed in such a manner which their upper surfaces are even and provided in a frame 6 through bearings 7 so as to rotate. The driving rollers 5A are connected with a driving motor 10 through a sprocket 8 and a chain 9 and rotated by the driving motor 10 in the direction which the plate material is transferred.

The pressing rollers 5B are connected with the frame 6 through vertical stands 11 so as to move in the vertical direction. The vertical stand 11 is provided with guiding grooves 12 on its both sides. Slits 13 of the frame 6 are guided into the guiding grooves 12 of the vertical stand 11. The vertical stand 11 is connected with the frame 6 so as to slide vertically along the slits 13. The upper surface of the vertical stand 11 is pressed by a pressing spring 14. The upper end of the pressing spring 14 is connected with the frame 6 and the lower end of the pressing spring 14 is connected with the vertical stand 11 and presses the vertical stand 11 down elastically. Both ends of the pressing roller 5B are connected with the vertical stands 11 through bearings so as to rotate.

When a plate material is transferred between the pressing roller 5B and the driving roller 5A, the plate material is pressed against the driving roller 5A since the upper surface of plate material is pressed by the pressing roller 5B. The plate material is sandwiched between the pressing roller 5B and driving roller 5A and transferred in a fixed direction since the driving roller 5A is rotated by the driving motor 10. To transfer the plate material without slipping, the driving and pressing rollers 5A, 5B can be also coated with elastic rubber material such as natural rubber and synthetic rubber.

Further, as shown in FIG. 5, the upper pressing roller 55B can be also made rotate and drive. This cutting device is provided with a driving motor 510 on the upper surface of a frame 56 and the pressing roller 55B is connected with the driving motor 510 through a sprocket 58 and a chain 59. The pressing roller 55B is rotated by the driving motor 510 in the direction which the plate material is transferred while pressing the upper surface of the plate material. The plate material sandwiched between the pressing and driving rollers 55B, 55A is rotated and transferred in a fixed direction. Thus the cutting device having the structure for making the pressing roller 55B rotate and drive has the feature that even thick and heavy plate materials can be certainly transferred by being sandwiched between the upper and lower rollers 55. In this figure, a sign of 54 shows a cutter blade and 525 shows an ultrasonic-vibrating mechanism.

In the above-mentioned feeding and discharging mechanisms, a plate material is sandwiched between and transferred by two rollers. In the cutting device of the present invention, a feeding and discharging mechanisms are not specified by the above-mentioned structure. For example, not illustrated, the feeding and discharging mechanisms can be replaced by a mechanism in which the plate material is sandwiched between and transferred by the upper and lower belt conveyors disposed on both surfaces of the plate material or a mechanism in which the plate material is sandwiched between and transferred by a belt conveyor disposed on one surface and a roller disposed on the other surface. Further, the feeding and discharging mechanisms are not necessarily the same mechanism. For example, the plate material is sandwiched between and transferred by rollers in the feeding mechanism and sandwiched between and transferred by belt conveyors in the discharging mechanism.

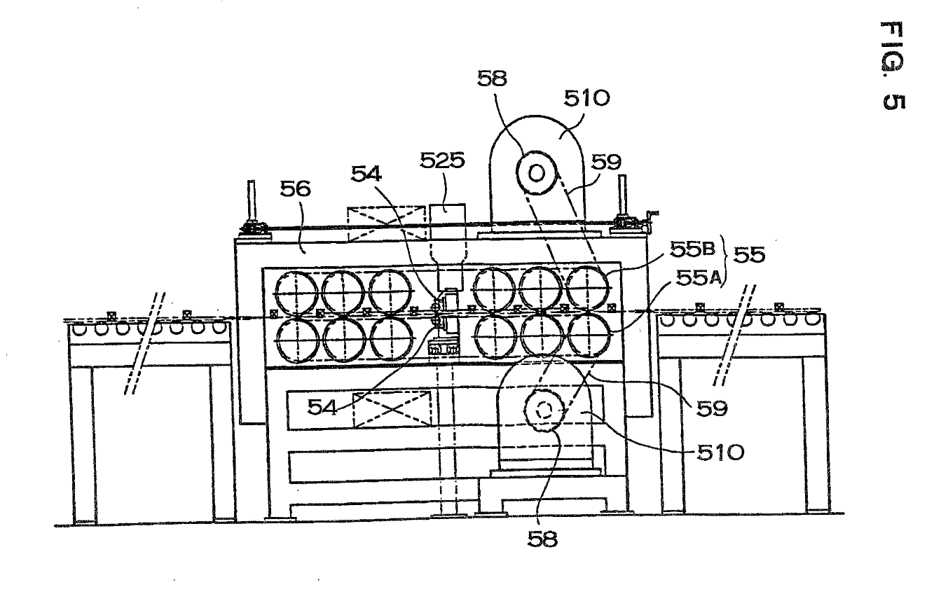

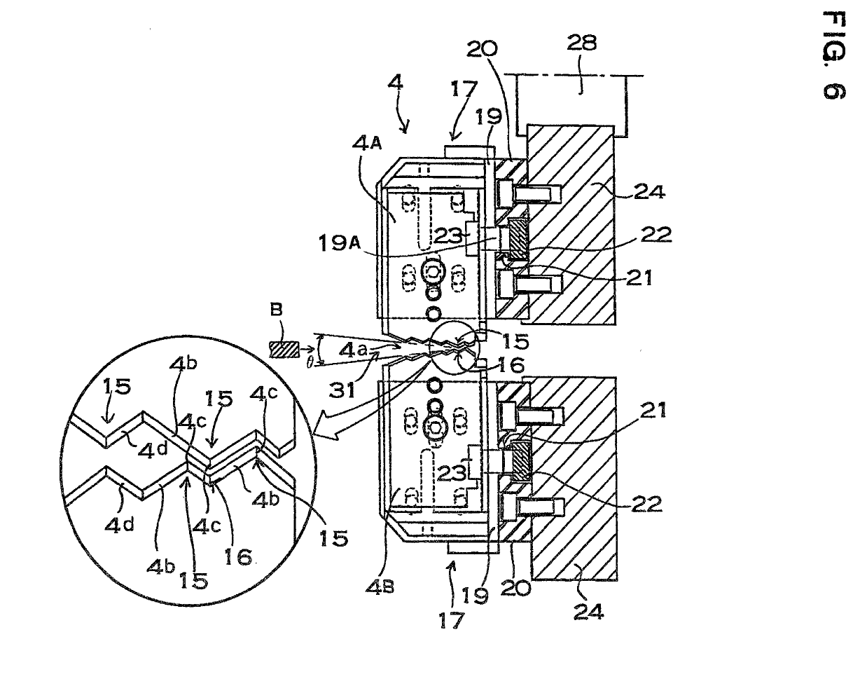

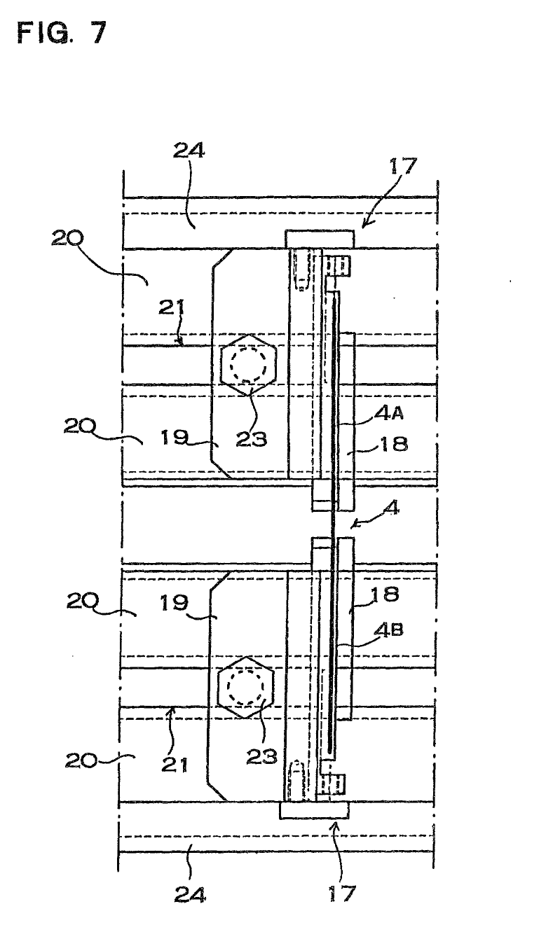

The cutting mechanism 2 has cutter blades 4 disposed above and below the plate material. The structure for attaching the cutter blades 4 is shown in FIGS. 6 and 7. The cutter blades 4 shown in these figures are entirely formed into a sheet-like shape. However, in the cutter blades 4, a portion for cutting can be only formed into a sheet-like shape without the whole of cutter blades 4. The cutter blades 4 are provided with a cutting portion 4a linearly disposed in parallel with the direction in which the plate material is transferred.

The cutting portion 4a of the cutter blade 4 formed into a sheet-like shape is gradually formed thinner toward the direction in which the plate material is transferred. This type of cutter blades can reduce frictional resistance to the plate material. This is because the pressing force of the cutting portion 4a against a cutting surface of the plate material is large locally in the first cutting portion and then reduced gradually. The cutting device of the present invention does not cut off a part of the plate material to a predetermined width like a saw but cuts out the plate material like a razor. For this reason, the frictional resistance of the cutter blades to the plate material becomes large. The structure for gradually forming a cutting portion 4a of cutter blades 4 thinner toward the direction in which the plate material is transferred is remarkably effective in reducing the frictional resistance as much as possible.

Cutter blades 4 are provided with a plurality of projecting cutter blades 15. The plurality of projecting cutter blades 15 are separately disposed at fixed intervals toward the direction in which the plate material is transferred to the cutter blades 4. Further, the plurality of projecting cutter blades 15 are gradually projected larger toward the direction in which the plate material advances. This is for the purpose of gradually inserting the plurality of projecting cutter blades 15 into the plate material deeper and cutting the plate material completely. Still further, the plurality of projecting cutter blades 15 are provided with acute inclined cutting edges 4b on one side so as to be gradually inserted deeper into the plate material transferred. The inclined cutting edges 4b for cutting the plate material are inclined toward the direction in which the plate material is transferred so as to be gradually inserted deeper into the plate material.

The projecting cutter blade 15 is provided with an inclined cutting edge 4b on one side and an inclined edge 4d on the other side. An oblique angle (α) of the inclined cutting edge 4b formed with the direction in which the plate material B advances toward the cutter blade 4 is smaller than an oblique angle (β) of the inclined edge 4d formed with the direction. This is for the purpose of cutting the plate material B smoothly with the inclined cutting edges 4b. The inclined cutting edges 4b are for cutting the plate material and the inclined edges 4d are not for cutting the plate material. Therefore, the inclined edges 4d are not provided with cutting edges. This type of cutter blades 4 can be manufactured in large quantities at low cost. This is because the inclined cutting edges are only provided with cutting edges and it is not necessary to provide the inclined edges with cutting edges.

The cutting device shown in the figures, a cutting portion 4a of the upper cutter blade 4A disposed above the plate material has inclined cutting edges 4b inclining downwardly to the direction in which the plate material is transferred. The inclined cutting edges 4b have tip cutting edges at their tips. The inclined cutting edges 4b are gradually projected larger toward the direction in which the plate material advances and form cone-shaped projecting cutter blades 15. The tip cutting edges 4c are disposed at the lower end of the projecting cutter blades. The upper cutter blade 4A is provided with a plurality of projecting cutter blades 15 at its lower edge.

The plurality of projecting cutter blades 15 are separately disposed at fixed intervals toward the direction in which the plate material is transferred to the cutter blade 4 and gradually projected larger and downwardly to the direction in which the plate material advances. Further the projecting cutter blades 15 have the inclined cutting edges 4b inclining downwardly to the direction in which the plate material advances. The inclined cutting edges 4b of the cutter blade 4 are inclined toward the direction in which the plate material is transferred so as to be gradually inserted deeper into the plate material transferred. The inclined cutting edges have acute cutting end edges at their end edges.

A cutting portion 4a of the lower cutter blade 4B disposed below the plate material is provided with inclined cutting edges 4b which are inclined upwardly to the direction in which the plate material is transferred. The inclined cutting edges 4b have tip cutting edges 4c at their tips. The inclined cutting edges 4b are gradually projected larger toward the direction in which the plate material advances and form cone-shaped projecting cutter blades 15. The tip cutting edges 4c are disposed at the upper end of the projecting cutter blades. The lower cutter blade 4B is provided with a plurality of projecting cutter blades 15 at its upper edge.

The plurality of projecting cutter blades 15 are separately disposed at fixed intervals toward the direction in which the plate material is transferred to the cutter blade 4 and gradually projected larger and upwardly to the direction in which the plate material is transferred. Further the projecting cutter blades 15 have the inclined cutting edges 4b inclining upwardly to the direction in which the plate material advances. The inclined cutting edges 4b of the cutter blade 4 are gradually inclined to the direction in which the plate material is transferred so as to be gradually inserted deeper into the plate material transferred. The inclined cutting edges 4b have acute cutting end edges at their end edges.

In cutter blades 4 shown in the figure, tips of the projecting cutter blades 15 of the upper cutter blade 4A are inserted into concave parts 16 disposed between the projecting cutter blades 15 of the lower cutter blade 4B at an introducing part 31 of the plate material and its opposite end, and the tip cutting edges 4c of the upper cutter blade 4A and the lower cutter blade 4B are disposed in such a manner as to be displaced back and forth. Further the tip cutting edges 4c of the upper cutter blade 4A are extended lower than the tip cutting edges 4c of the lower cutter blade 4B to cut off the plate material completely.

The cutter blades 4 are attached to cutter blade stands 24 through cutter blade holders 17. The cutter blades 4 are fixed to the cutter blade holders 17 with being sandwiched between cutter blade pressers 18. The cutter blade pressers 18 sandwiching the cutter blades 4 are screwed to the cutter blade holders 17. The cutter blade holders 17 are formed in a L-shape and provided with brackets 19 which are fixed to a predetermined position of the cutter blade stands 24. The brackets 19 are fixed to the predetermined position of guiding rails 20 of the cutter blade stands 24. The brackets 19 are provided with guiding protrusions 19A which are inserted tightly into slits 21 of the guiding rails 20 so as to move horizontally along the guiding rails 20 in a predetermined posture. Sliders 22 are provided on the inner surfaces of the slits 21. The sliders 22 have set screws 23 passing through the brackets 19 for fixing the cutter blade holders 17 to a predetermined position of the guiding rails 20. The guiding rails 20 are fixed to the cutter blade stands 24 which are disposed in parallel with rollers.

In a cutting device for cutting the plate material to more than 3 plates with a plurality of pairs of cutter blades, the plurality of pairs of cutter blades are fixed to the guiding rails at predetermined intervals. The set screws 23 in the position which the cutter blades 4 are fixed are loosened, the cutter blade holders 17 are moved along the guiding rails 20 and the set screws 23 are screwed up and fixed in a predetermined position. If the number of cutter blades 4 fixed to the guiding rails 20 is increased, the plate material can be cut and divided into a multiplicity of plates at one time.

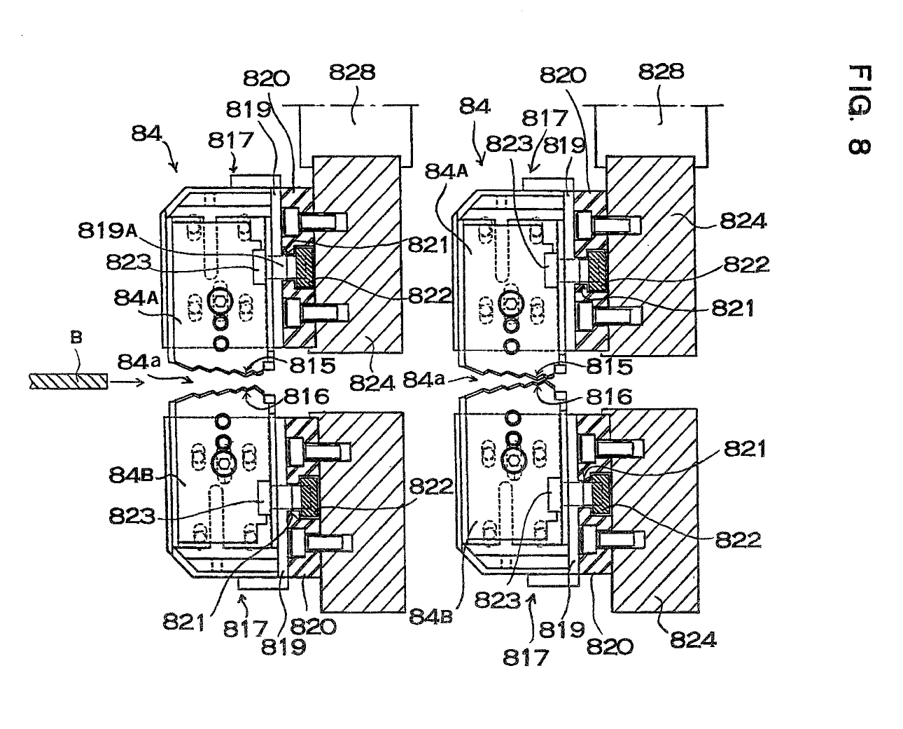

A cutting mechanism shown in the figures cuts off the plate material with a pair of cutter blades 4 disposed above and below the plate material. The cutting device with this structure can cut the plate material that is less than a thickness of 20 mm by passing the plate material through a pair of cutter blades 4. When the plate material is thick, as shown in FIG. 8, the plate material is gradually cut deeper with a plurality of pairs of cutter blades 4 disposed separately back and forth and cut off completely with the last pair of cutter blades 4. The cutting device having this structure can efficiently cut a thick plate material by passing the plate material through two pairs of cutter blades 4. Further, the cutting device can cut even thicker plate materials by increasing the number of the cutter blades 4.

In FIG. 8, a plurality of cutter blades 84 comprises the upper cutter blade 84A and the lower cutter blade 84B are disposed separately in the direction which the plate material B is transferred. As shown in FIG. 9, the upper cutter blade and lower cutter blade can be disposed separately in the direction which the plate material B is transferred without being disposed in such a manner which the upper cutter blade 94A opposes to the lower cutter blade 94B. Further in FIGS. 8 and 9, the same structure elements as described in the previous embodiment are marked with the same numbers as described in the previous embodiment, however one figure from the top is eliminated.

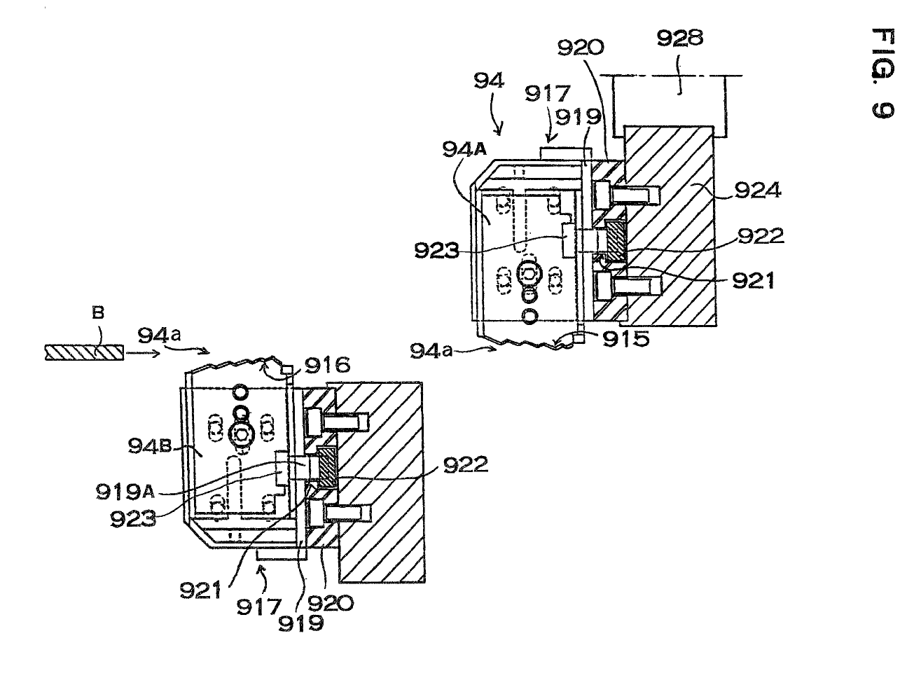

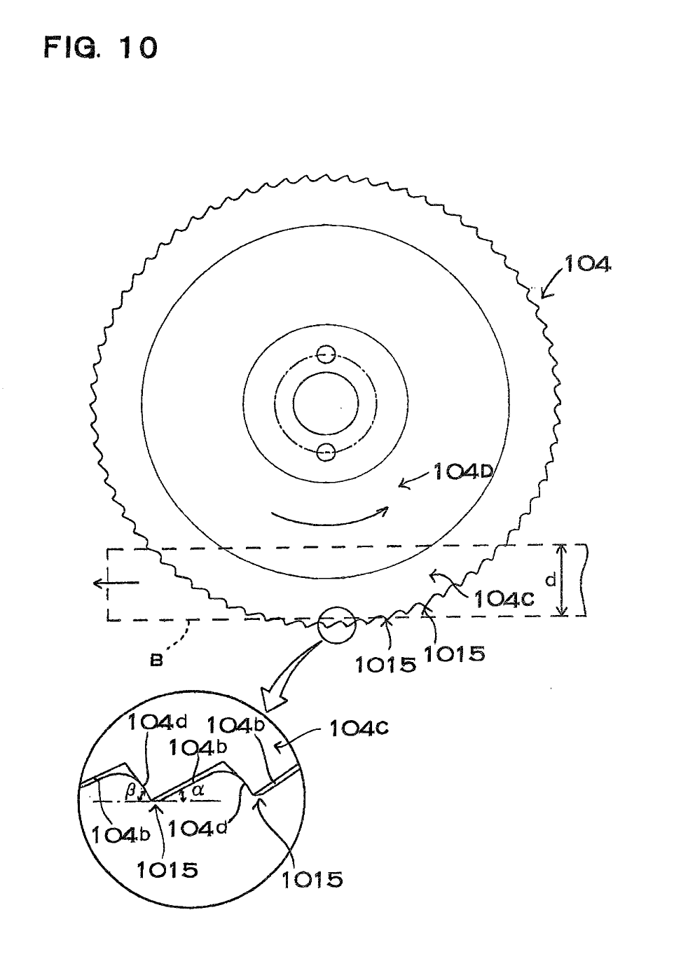

Further, as shown in FIG. 10, a cutter blade can be also formed into a disk-shape. The cutter blade is provided with an outer circumferential cutting portion 104C for cutting the plate material B on its outer circumference, which is formed into a sheet-like shape. The outer circumferential cutting portion 104C is disposed in parallel with the direction in which the plate material is transferred to the cutter blade 104 and provided with a plurality of projecting cutter blades 1015 disposed separately in the direction of the circumference. Each projecting cutter blade 15 is provided with an inclined cutting edge 104b, which is acute cutting edge, for cutting the plate material on one side and an inclined edge 104d not for cutting the plate material on the other side. An oblique angle (α) of the inclined cutting edge 104b formed with the tangent line of the circumference is smaller than an inclined angle (β) of the inclined edge 4d formed with the line.

In the cutter blade 104 shown in the figure, the oblique angle of the inclined cutting edge 104b becomes even smaller at a tip portion of the projecting cutter blade 1015. This type of cutter blade 104 can efficiently cut a plate material while effectively preventing the tip cutting edge of the cutter blade 1015 from being broken. This is because the plate material can be efficiently cut with the tip portion of the inclined cutting edge 104b having a considerably small oblique angle. The inclined cutting edge 104b touches the plate material at a considerably small angle, namely in approximately parallel with the direction in which the plate material is transferred. The inclined cutting edge touching the plate material at a considerably small angle can cut the plate material smoothly.

Further, in the cutter blade 104 shown in the figure, the distance between adjacent projecting cutter blades 1015 can be formed narrow while making the oblique angle of the inclined cutting edge 104b smaller since the oblique angle of the inclined edge 104d is larger than the oblique angle of the inclined cutting edge 104b. This is effective in cutting a plate material smoothly. This is because the plate material can be smoothly cut with the inclined cutting edge 104b by making the oblique angle of inclined cutting edge 104b smaller and with a multiplicity of inclined cutting edges 104b by narrowing the distance between the adjacent projecting cutter blades 1015.

In the cutter blade 104, the plate material B is cut not with the inclined edge 4d having a large oblique angle but with the inclined cutting edge 4b having a small oblique angle. Therefore, this type of cutter blade can be manufactured in large quantities at low cost since the inclined cutting edge is only provided with a cutting edge and it is not necessary to provide the inclined edge 4d with a cutting edge.

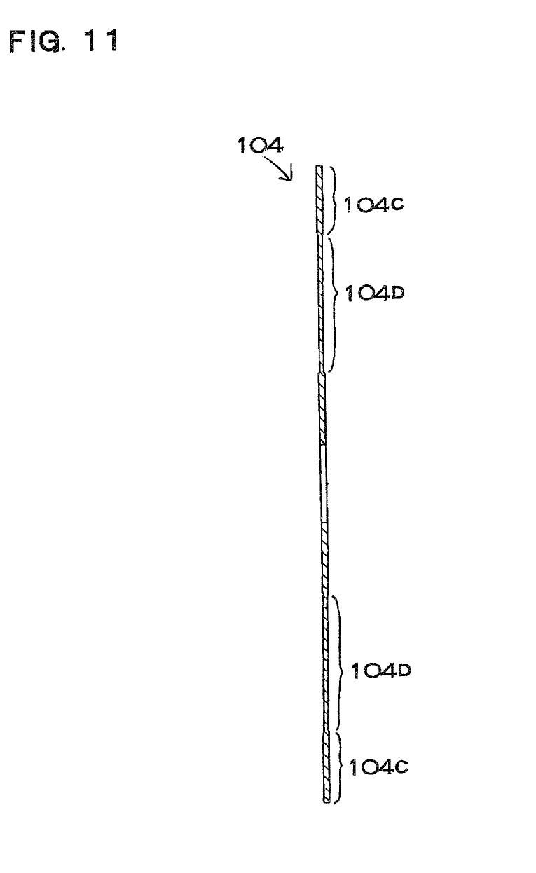

As shown in FIG. 11, in a disk-shaped cutter blade 104, an outer circumferential cutting portion 104C is thicker than an inner circumferential portion 104D which is disposed inside of the outer circumferential cutting portion 104C. This is for the purpose of reducing pressure of the inner circumferential portion 104D against a plate material cutting surface when cutting the plate material. A chain line in FIG. 10 shows a state in which the cutter blade 104 cuts a plate material B having a thickness of d. In this figure, the plate material B is disposed in such a manner which its cutting surface is opposed to the outer circumferential cutting portion 104C and the inner circumferential portion 104D. The cutting surface of the plate material B is pressed against a surface of the inner circumferential portion 104D and slid there, namely transferred with generation of frictional resistance. In the inner circumferential portion 104D that is thinner than the outer circumferential cutting portion 104C, the pressure applied to the cutting surface of plate material B can be reduced. This is because the inclined cutting edge 104b expands the opposing cutting surface of plate material B up to the thickness of the outer circumferential cutting portion 104C.

Reducing frictional resistance of a cutter blade to a plate material is important in transferring the plate material and cutter blade smoothly. A disk-shaped cutter blade cuts the plate material by rotating like a saw or cuts the plate material without rotating. The disk-shaped cutter blade, which cuts the plate material without rotating, cuts the plate material with a part of the cutting portion. If the cutting portion cut a multipicity of plate materials and was worn while cutting, the disk-shaped cutter blade would be rotated slightly. The cutter blade, which is rotated, can cut the plate material with a new cutting portion. A cutting device in which a disk-shaped cutter blade cuts the plate material by rotating is effective in cutting the plate material by reducing rotating torque of the cutter blade. Further a cutting device in which a disk-shaped cutter blade and plate material are transferred in such a manner which the cutter blade is not rotated can transfer the plate material and cutter blade smoothly and easily.

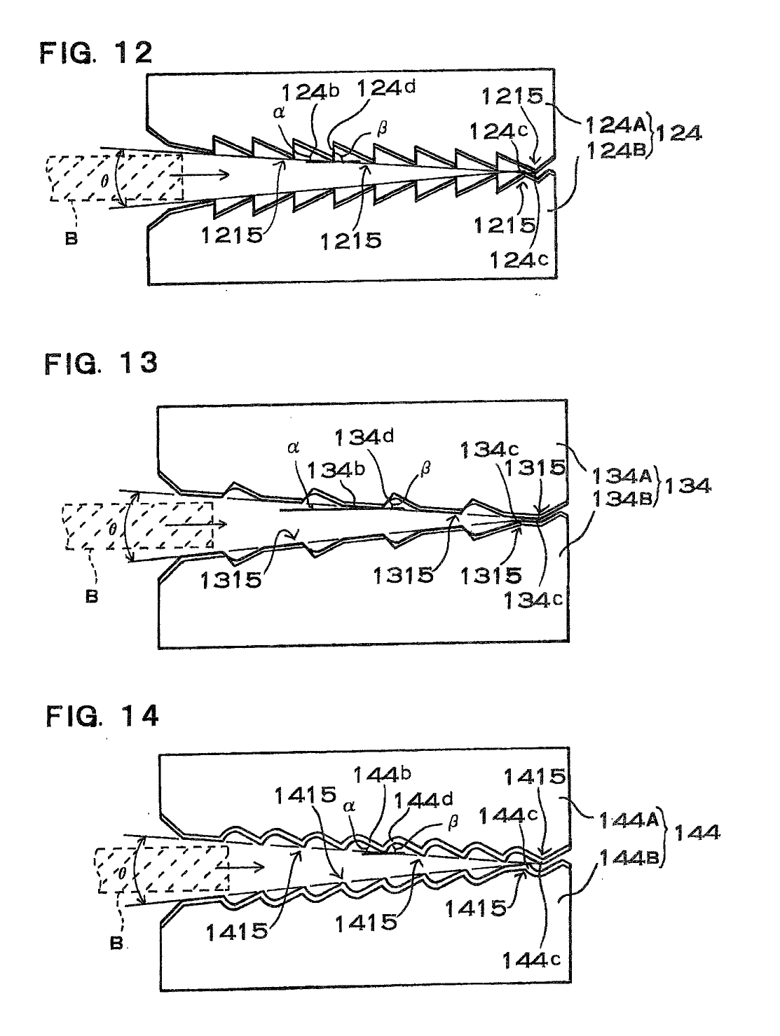

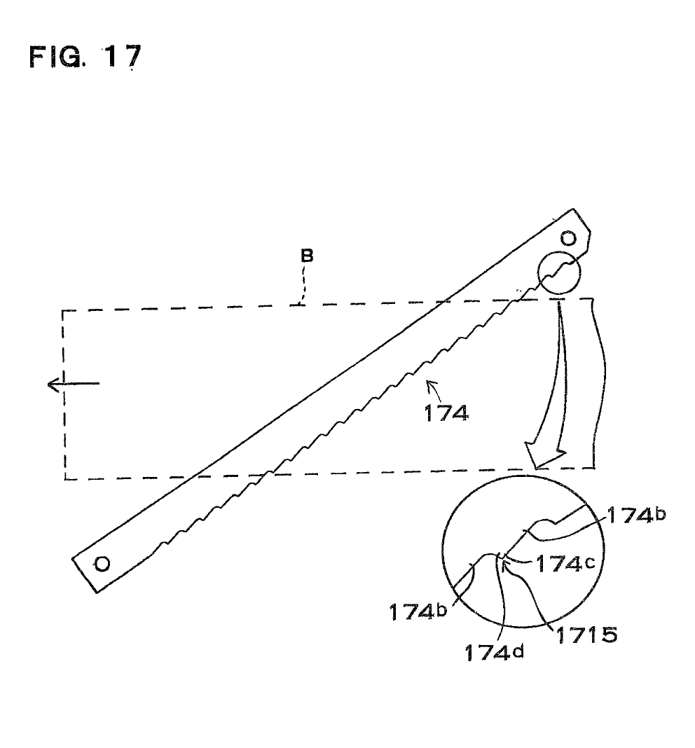

Further cutter blades can be formed into shapes shown in FIGS. 12 through 17. In FIGS. 12 through 16, cutter blades 124, 134, 144, 154, 164 are can efficiently cut a thick plate material since the cutter blades are disposed above and below the plate material B. Further in the cutter blades 124, 134, 144, 154, 164, a tip cutting edge 124c, 134c, 144c, 154c, 164c of the largest projecting cutter blade 1215, 1315, 1415, 1515, 1615 of the upper cutter blade 124A, 134A, 144A, 154A, 164A and a tip cutting edge 124c, 134c, 144c, 154c, 164c of the largest projecting cutter blade 1215, 1315, 1415, 1515, 1615 of the lower cutter blade 124B, 134B, 144B, 154B, 164B are disposed in such a manner as to be displaced back and forth in the direction which the plate material is transferred and the tip cutting edge 124c, 134c, 144c, 154c,164c of the upper cutter blade 124A, 134A, 144A, 154A, 164A is extended lower than the tip cutting edge 124c, 134c, 144c, 154c,164c of the lower cutter blade 124B, 134B, 144B, 154B, 164B. Therefore, the plate material B passing through the cutter blades 124, 134, 144, 154, 164 can be cut off completely. However, as shown in FIG. 17, in the present invention, a single cutter blade 174 is disposed above and below the plate material B so as to pass through the plate material B to cut the plate material B. In addition, the cutting device of the present invention can be provided with a cutter blade disposed only above or only below the plate material B to cut the plate material B. Especially, a cutting device in which the plate material is out with a vibrating cutter blade can cut the plate material with the cutter blade disposed either above or below the plate material B.

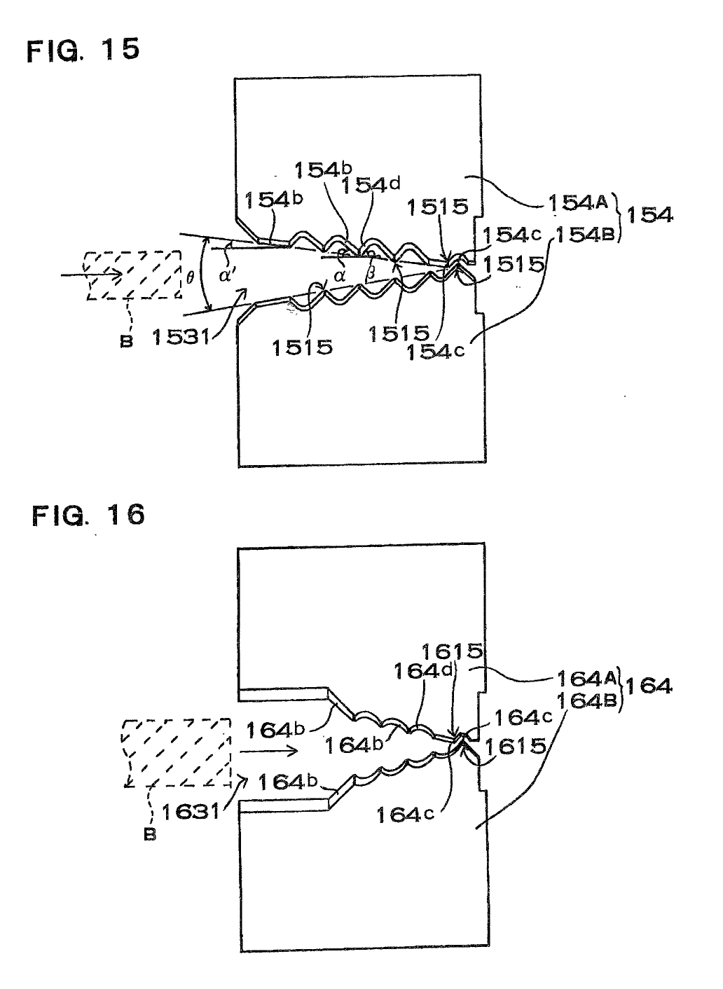

In cutter blades 124 shown in FIG. 12, an oblique angle (β) of an inclined edge 124d is a right angle. This type of cutter blades have the feature that the distance between adjacent projecting cutter blades 1215 can be formed considerably narrow. Further, in cutter blades 134 shown in FIG. 13, the tip portion of the inclined cutting edge 134b has smaller oblique angle (α) than the back end portion. In cutter blades 144 shown in FIG. 14, bottom portions of the inclined cutting edge 144b and inclined edge 144d are curved. In the cutter blades 144 formed in this manner, an oblique angle (α) of the inclined cutting edge 144b and (β) of the inclined edge 144d mean oblique angles of tip portions of the projecting cutter blades 1415. Still further in cutter blades 154 shown in FIG. 15, an oblique angle (α′) of the inclined cutting edge 154b disposed in an introducing part 31 which cuts the plate material first is formed smaller than any other oblique angles (α) of the inclined cutting edges 154b. In addition, cutter blades 164 shown in FIG. 16 are provided with inclined cutting edges 164b that are longer than any other inclined cutting edges 164b in the introducing part 1631. In these figures, a sign of 124b shows an inclined cutting edge and 134d, 154d and 164d show inclined edges.

In a cutting device that cuts a plate material with two cutter blades 4 disposed above and below the plate material, an introducing angle (θ), namely an angle which is formed by two lines connecting tips of a plurality of projecting cutter blade 15 of the upper and lower cutter blades 4, is 10 degrees to 50 degrees, preferably 15 degrees to 45 degrees. The cutter blades can not cut the plate material smoothly and efficiently if the introducing angle (θ) is too small or too large. If the introducing angle (θ) is too small, the distance of cutter blades for cutting the plate material becomes too long, in contrast with this, if the introducing angle (θ) is too large, the cutter blades can not cut the plate material efficiently since an angle of the inclined cutting edge of cutter blade formed with the plate material becomes too large.

Further, as shown in FIG. 17, a cutter blade 174 is formed in a slender plate-shape and fixed at its upper and lower ends, and a plate material B is passed through the indermediate between the ends. The cutter blade 174 with this structure can cut the plate material with a clean cutting surface compared with a cutting device having two cutter blades disposed above and below the plate material since the plate material is cut with a single cutter blade. When minutely observing the cutter blades disposed above and below the plate material, the upper and lower cutter blades are not always positioned on the same plane. If the upper and lower cutter blades are not positioned on the same plane, the cutting surface becomes uneven slightly. Especially when cutting a thick and hard plate material, the plate material is deformed and displaced, and thereby the cutting surface becomes rough.

The single cutter blade shown in FIG. 17 is disposed at an angle of 10 degrees to 45 degrees, preferably 20 degrees to 40 degrees, more preferably 25 degrees to 35 degrees, the most preferably 30 degrees with respect to the direction in which the plate material is transferred. If the angle is too small or too large, the plate material can not be cut efficiently. When the angle is too small, the cutter blade can not cut the plate material efficiently since the distance of the cutter blade for cutting the plate material becomes long and strength of the cutter blade is also lowered. When the angle is too large, the cutter blade can not cut the plate material efficiently since an angle between the inclined cutting edge and the plate material becomes large. In this figure, a sing of 174a shows an inclined cutting edge, 174d shows an inclined edge, 174c shows a tip cutting edge and 1715 shows a projecting cutter blade.

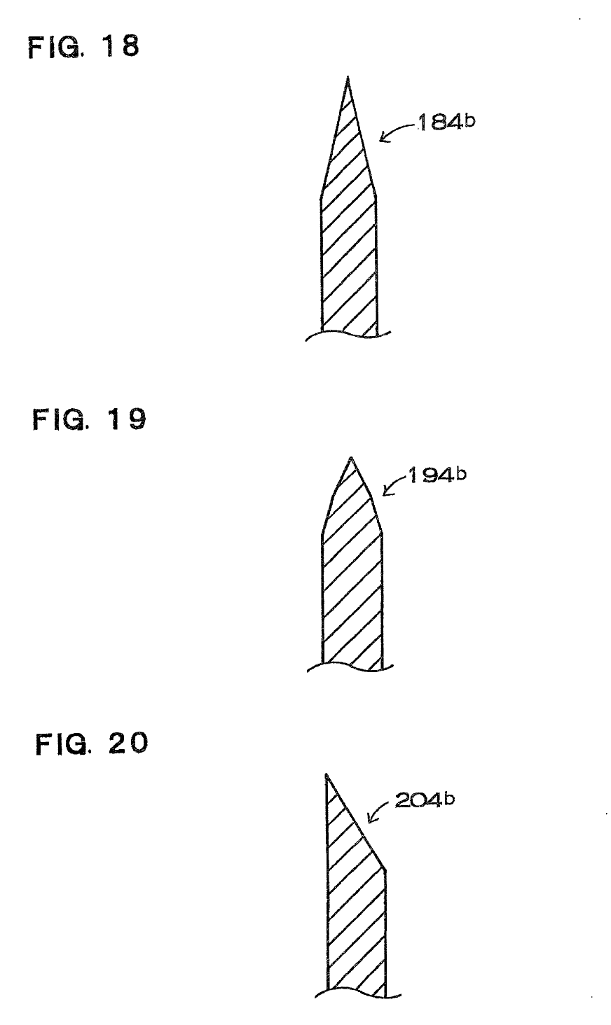

An inclined cutting edge of cutter blade is formed in a double-edged shape shown in cross-section views of FIGS. 18 and 19 or in a single-edged shape shown in FIG. 20. The inclined cutting edges 184b, 194b formed in a double-edged shape are not applied the force of slipping sideways when cutting a plate material. For this reason, these cutting edges can easily cut the plate material in a linear fashion. The inclined cutting edge 204b formed in a single-edged shape can be manufactured at low cost since only one side of the cutter blade is provided with a cutting edge. Soft and flexible corrugated cardboard can be sufficiently cut with the inclined cutting edge formed in a single-edged shape.

A cutter blade can efficiently cut a considerably thick and hard plate material by vibration. The cutter blade is connected with an ultrasonic-vibrating mechanism and ultrasonic-vibrated. An ultrasonic-vibrating mechanism shown in FIG. 2 vibrates the upper cutter blade 4A only. However, the cutting device of the present invention can vibrate both the upper and lower cutter blades and further also vibrate the lower cutter blade only.

The ultrasonic-vibrating mechanism 25 is provided with an ultrasonic power source 26 for sending ultrasonic electric signals, a magnetostrictive converting device 27 ultrasonic-vibrated by driving the ultrasonic power source 26 and a vibrating stand 28 for transmitting ultrasonic vibration of the magnetostrictive converting device 27 to cutter blades 4. A bottom end of the vibration stand 28 is fixed to a cutter blade stand 24.

The magnetostrictive converting device 27 is made of a core 29 which is wound by a coil 30. The coil 30 is connected with the ultrasonic power source 26. The ultrasonic power source 26 allows the coil 30 of magnetostrictive converting device 27 with an alternating current and ultrasonic-vibrates the magnetostrictive converting device 27. An alternative current frequency for the ultrasonic power source exciting the coil 30 of magnetostrictive converting device 27 is preferably 15 kHz to 30 kHz. In FIG. 2, the magnetostrictive converting device 27 ultrasonic-vibrates its bottom end vertically. The ultrasonic vibration at the bottom end is transmitted to the cutter blade 4 through the vibrating stand 28.

The vibrating stand 28 shown in FIG. 2 is a horn for amplifying ultrasonic amplitude and adjusting ultrasonic vibration. When the horn for amplifying ultrasonic amplitude is used for the vibrating stand 28, a plate material is efficiently cut by large amplitude vibration. However, in the cutting device of the present invention, a horn is not necessarily used for a vibrating stand. Further a magnetostrictive converting device can be also directly connected with a cutter blade 4 without the vibrating stand.

In the vibrating stand 28 shown in the figure, the first horn 28A is connected with the second horn 28B in series and a bottom of the second horn 28B is connected with the cutter blade stand 24, The ultrasonic-vibrating mechanism 25 transmits ultrasonic vibration of the magnetostrictive converting device 27 to the cutter blade stand 24 through the vibrating stand 28 comprising the first horn 28A and second horn 28B. The cutter blade 4 is vibrated in a vertical direction by the vertical ultrasonic vibration of the bottom of magnetostrictive converting device 27. A cutting device in which a cutter blade having inclined cutting edges 4b is vibrated in a vertical direction has the feature that the plate material can be efficiently cut by vibration of the cutter blade 4. Further the cutter blade, but not illustrated, can be also vibrated in a horizontal direction, namely in parallel with the direction in which the plate material advances.

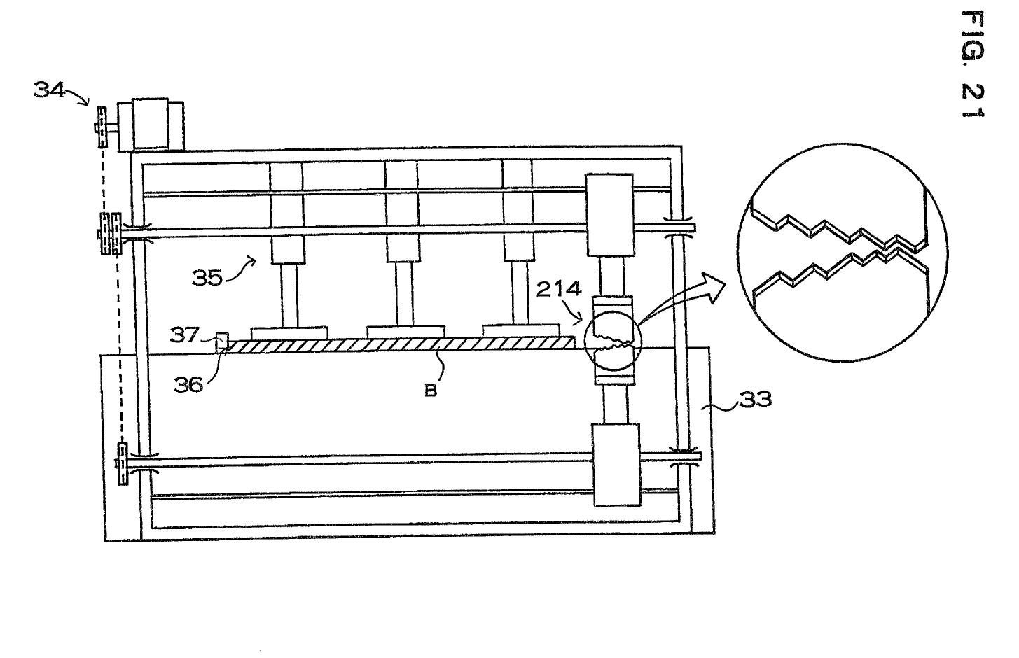

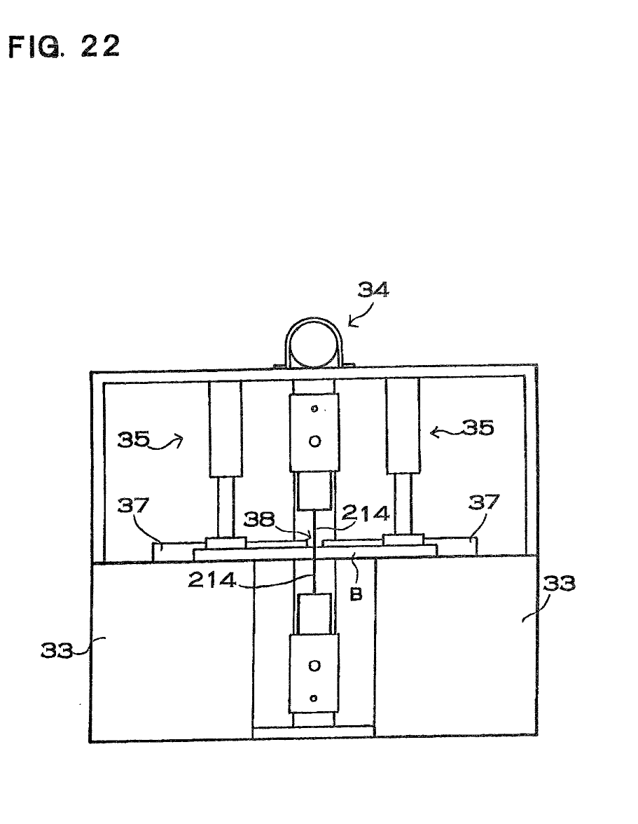

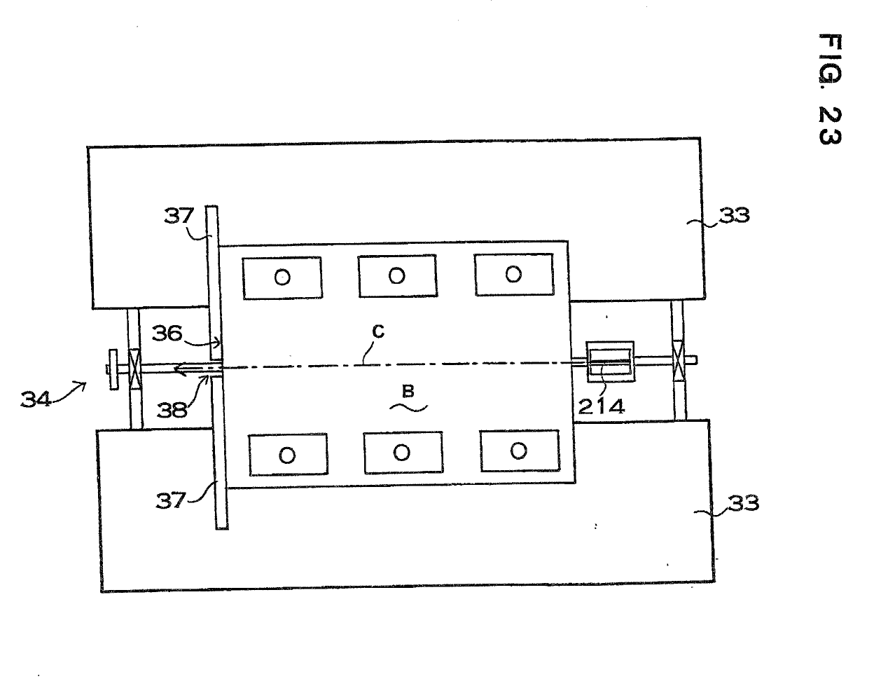

The cutting devices described in above embodiments can cut the plate material in such a manner which cutter blades are fixed and a plate material is transferred to the cutter blades. As shown in FIGS. 21 through 23, a cutting device can also cut the plate material in such a manner which the plate material B is fixed and the cutter blades 214 are transferred to the plate material B. The cutting device shown in these figures is provided with a base 33 for detachable fixing the plate material B and a driving mechanism 34 for moving cutter blades 214 for cutting the plate material B fixed on the base 33 in the direction which the plate material is cut. The base 33 is provided with fixing mechanisms 35 for fixing the plate material B on its upper surface. The fixing mechanisms 35 fix the plate material B to be cut with the cutter blades 214 in such a manner as to sandwich the plate material B. In the cutting device shown in the figures, the plate material is sandwiched between the fixing mechanisms 35 at both ends of a cutter blade-cutting-locus C.

Further the cutting device shown in the figures is provided with a stopper 37 touching the last cutting surface 36 of the plate material B which is fixed on the base 33 by the fixing mechanisms 35. The stopper 37 is disposed on the last cutting surface 36 so that the plate material B to be cut with the cutter blades 4 may not move in the direction which the cutter blades 4 move. In the cutting device shown in the figures, the stopper 37 is fixed on the base 33, The stopper 37, not illustrated, can be fixed to a frame for fixing the base 33.

The stopper 37 is provided with a cutter blade passage 38 for making the cutter blades 214 pass through the cutter blade-cutting-locus C so that the cutter blades 214 may move along the plate material B while preventing slipping from the position of the plate material B, in other words, so that the cutter blades 214 moving along the cutter blade-cutting-locus C may not collide with the stopper 37. The stopper 37 shown in the figures has a cutter blade passage 38 formed in a slit-shape. The slit-shaped cutter blade passage 38 is formed larger than the thickness of the cutter blades 214 so that the cutter blades 214 can pass through.

In the cutting device shown in the figures, the cutter blades 214 are disposed above and below the plate material B. However the cutter blades can use the same structure as the above-mentioned cutting device in which the plate material is transferred.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within meets and bounds of the claims, or equivalence of such meets and bounds thereof are therefore intended to be embraced by the claims.

What is claimed is:

1. A cutting device for plate materials in which cutter blades and a plate material are relatively transferred and the plate material is cut with a cutting portion of the cutter blades comprising:
the cutter blades provided with a plurality of projecting cutter blades disposed in the cutting portion;
the plurality of projecting cutter blades separately disposed at fixed intervals in the direction which the plate material is transferred to the cutter blades and gradually projected larger toward the direction in which the plate material advances; and
the projecting cutter blades having inclined cutting edges which are acute cutting edges for cutting the plate material in such a manner as to be gradually inserted deeper into the plate materials transferred to the cutter blades, wherein the inclined cutting edges are inclined toward the direction in which the plate material is transferred so as to be gradually inserted deeper into the plate materials.

2. A cutting device for plate materials as recited in claim 1 wherein the projecting cutter blade is provided with the inclined cutting edge for cutting the plate materials on one side and an inclined edge not for cutting the plate materials on the other side and an oblique angle [α] of the inclined cutting edge formed with the direction in which the plate material advances to the cutter blades is smaller than an oblique angle [β] of the inclined edge formed with the direction.

3. A cutting device for plate materials as recited in claim 2 wherein the inclined edge is not provided with a cutting edge.

4. A cutting device for plate materials as recited in claim 2 wherein an oblique angle [α] in a tip portion of the inclined cutting edge is smaller than in a back end portion.

5. A cutting device for plate materials as recited in claim 2 wherein an oblique angle [α′] of the inclined cutting edge disposed in an introducing part which cuts the plate materials first is smaller than any other oblique angles [α] of the inclined cutting edges.

6. A cutting device for plate materials as recited in claim 2 wherein the inclined cutting edges disposed in the introducing part which cuts the plate materials first are longer than any other inclined cutting edges.

7. A cutting device for plate materials as recited in claim 1 wherein the plate material is cut in such a manner which the cutter blades are fixed and the plate material is transferred to the cutter blades.

8. A cutting device for plate materials as recited in claim 1 wherein the plate material is cut in such a manner which the plate material is fixed and the cutter blades are transferred to the plate material.

9. A cutting device for plate materials as recited in claim 1 wherein the cutting portion of the cutter blades is formed into a sheet-like shape and gradually formed thinner toward the direction in which the plate material is transferred to the cutter blades.

10. A cutting device for plate materials as recited in claim 1 wherein the cutter blades are disposed above and below the plate material in a linear fashion.

11. A cutting device for plate materials as recited in claim 10 wherein an introducing angle [θ] formed by two lines connecting tips of a plurality of projecting cutter blades of the upper and lower cutter blades is 10 degrees to 50 degrees.

12. A cutting device for plate materials as recited in claim 1 wherein a plurality of pairs of cutter blades are separately disposed in such a manner which the plate material can be gradually cut deeper in the direction which the plate material is transferred.

13. A cutting device for plate materials as recited in claim 1 wherein the upper and lower cutter blades are respectively disposed above and below the plate material and the upper and lower cutter blades are separately disposed in the direction which the plate material advances.

14. A cutting device for plate materials as recited in claim 1 wherein a single cutter blade is disposed in such a manner as to pass through both surfaces of the plate material.

15. A cutting device for plate materials as recited in claim 1 wherein the cutter blades are connected with an ultrasonic-vibrating mechanism.

16. A cutting device for plate materials in which the cutter blade and the plate material are relatively transferred and the plate material is cut with the cutting portion of the cutter blade comprising:
the cutter blade formed in a disk-shape and at least provided with an outer circumferential cutting portion for cutting the plate material on its outer circumference which is formed into a sheet-like shape;
wherein the outer circumferential cutting portion is disposed in parallel with the direction in which the plate material is transferred to the cutter blade;
wherein the outer circumferential cutting portion of the cutter blade has the plurality of projecting cutter blades disposed separately in the direction of the circumference;
wherein each projecting cutter blade provides with the inclined cutting edge which is an acute cutting edge for cutting the plate material on one side and the inclined edge not for cutting the plate material on the other side; and
wherein the oblique angle [α] of the inclined cutting edge is formed with a circumferential tangent line being smaller than the oblique angle [β] of the inclined edge formed with the line.

17. A cutting device for plate materials as recited in claim 16 wherein the plate material is cut with the cutter blades rotating.

18. A cutting device for plate materials as recited in claim 16 wherein the plate material is cut in such a manner which the cutter blade is fixed and the plate material is transferred to the cutter blade.

19. A cutting device for plate materials as recited in claim 16 wherein the outer circumferential cutting portion of the cutter blade is formed thicker than the inner circumferential portion disposed inside of the outer circumferential cutting portion.

20. A cutting device for plate materials as recited in claim 16 wherein the inclined edges are not provided with cutting edges.
